(19) United States
(12) Patent Application Publication
(10) Pub. No.: US 2026/0168541 A1
(43) Pub. Date: Jun. 18, 2026

(54) MULTI-DISC BRAKE/CLUTCH WITH A WEAR-ADJUSTMENT DEVICE

(71) Applicant: AUDI AG, Ingolstadt (DE)

(72) Inventors: Tassilo SCHOLLE, Gaimersheim (DE); Lucca Melander SWINDT, Ingolstadt (DE); Thomas HANISCH, Dollnstein (DE)

(21) Appl. No.: 19/417,197

(22) Filed: Dec. 11, 2025

(30) Foreign Application Priority Data
Dec. 13, 2024 (DE) 10 2024 137 648.1

(51) Int. Cl. F16D 13/75; F16D 13/52; F16D 55/36; F16D 65/52; F16D 121/14; F16D 129/04

(52) U.S. Cl. CPC F16D 13/757; F16D 13/52; F16D 55/36; F16D 65/52; F16D 2121/14; F16D 2129/04

(57) ABSTRACT

A multi-disc brake/clutch is disclosed, and may include a disc pack and an actuator configured to apply a contact pressure to the disc pack and having an adjustment device configured to reduce an excess clearance formed in the disc pack due to wear. The adjustment device may include a ramp assembly formed between the disc pack and the actuator with at least one ramp surface rotationally fixed about a disc pack axis and an axially adjacent rotatable ramp surface. When the rotatable ramp surface is rotated, the ramp assembly may expand axially by an adjustment travel.

### BACKGROUND

### Technical Field

The present disclosure relates to a multi-disc brake/clutch with a wear-adjustment device.

### Description of the Related Art

A multi-disc brake commonly has a disc pack and an actuator, by way of which the disc pack may be subjected to a contact pressure in order to load the multi-disc brake. In addition, the multi-disc brake has an adjustment device that may be used to reduce an excess clearance in the disc pack caused by wear that exceeds a factory-set nominal clearance.

DE102015201872A1 discloses a multi-disc clutch with an adjustment mechanism for automatic compensation of a wear-induced change in position of a displacement element guided in a displacement direction. DE2652060A1 discloses a disc brake with a self-acting mechanical adjustment device that has a spring mechanism. DE10351464A1 describes a multi-disc brake or a multi-disc clutch that has a mechanical adjustment device with a ring piece in combination with a spring.

### BRIEF SUMMARY

The present disclosure provides a multi-disc brake/clutch in which an automatic adjustment of axial wear of the multi-disc brake/clutch may be easily carried out.

The present disclosure relates to a multi-disc brake/clutch with a disk pack and an actuator by way of which a contact pressure may be applied to the disc pack. In addition, the multi-disc brake/clutch has an adjustment device that may be used to reduce an excess clearance in the disc pack caused by wear that exceeds a factory-set nominal clearance. The multi-disc brake/clutch may enable a structurally simple and automatic adjustment of the clearance. The adjustment device may have a ramp assembly formed between the disc pack and the actuator. The ramp assembly may be configured with at least one ramp surface that is rotationally fixed about a multi-disc brake axis and an axially adjacent rotatable ramp surface. When the rotatable ramp surface is rotated, the ramp assembly may expand axially by an adjustment distance, whereby the excess clearance may be reduced or compensated for, and the nominal clearance may be restored.

In some embodiments, the adjustment device may have an adjustment ring arranged axially between the disc pack and the actuator. In such embodiments, the rotatable ramp surface may be an integrally formed, one-piece component of the adjustment ring, whereas the non-rotatable ramp surface may be an integrally formed, one-piece component of a non-rotatable fixed disc of the disc pack.

In some embodiments, the actuator may have a pair of plates comprising a fixed plate that is adjustable in the axial direction by one actuator travel but is rotationally fixed, and a rotating plate that is rotatable but not adjustable in the axial direction. Such embodiments may save space axially. A ball-ramp mechanism may act between the rotating plate and the fixed plate. To load the multi-disc brake/clutch, a rotary drive may rotate the rotating plate by a rotation angle. This rotation may cause the fixed plate to be displaced by the actuator travel in order to exert the contact pressure on the disc pack. The fixed plate may be arranged axially adjacent to the adjustment ring, whereas the rotating plate may be axially spaced apart therefrom, with the fixed plate positioned in between.

With regard to simple rotational actuation of the adjustment ring, the adjustment device may have a ratchet mechanism with a ratchet pawl. The ratchet pawl may be in toothed engagement by way of ratchet toothing with an adjustment ring toothing, as well as being adjustable in the circumferential direction by an actuation travel.

A ratchet pawl displacement may be upstream of the actual rotational actuation of the adjustment ring. The ratchet pawl displacement may take place along the adjustment ring toothing when the multi-disc brake/clutch is in the loaded state. During such displacement, the adjustment ring may be pressed to be rotationally fixed between the disc pack and the actuator. The ratchet pawl displacement may occur under the buildup of a spring-return force.

Following the ratchet pawl displacement, the adjustment ring may be rotated when the multi-disc brake/clutch is in the unloaded state. When the multi-disc brake/clutch is in the unloaded state, the adjustment ring may no longer be rotationally fixed between the disc pack and the actuator, but may instead may be configured to be freely rotatable. Such a configuration enables the adjustment ring rotational actuation to take place, during which the ratchet pawl, which is in toothed engagement with the adjustment ring toothing, to return to the initial position as the spring-return force is relieved. At the same time, the ratchet pawl may turn the adjustment ring by the actuation travel. The ramp assembly may extend accordingly by the adjustment travel. The ratchet pawl may be mounted on the fixed plate so that the ratchet pawl is displaceable in the circumferential direction.

The present disclosure provides a ratchet pawl displacement that may be carried out automatically and may be upstream of the actual rotational actuation of the adjustment ring. For example, the ratchet pawl may have a driver by way of which the ratchet pawl can be coupled to a movement stop of the rotating disc.

The ratchet pawl driver and the movement stop of the rotating disc may interact in a multi-disc brake/clutch that is set with a nominal clearance, i.e., without excess clearance, by way of the rotary drive rotating the rotating plate by a nominal rotation angle from the unloaded state to the loaded state. In such a rotation of the rotating plate beyond the nominal rotation angle, the ratchet pawl driver may remain movement-decoupled from the movement stop of the rotating plate.

In contrast, in a multi-disc brake/clutch that has excess clearance the rotary drive may rotate the rotating plate from the unloaded state to the loaded state by a rotation angle that is greater than the nominal rotation angle by an additional angle. In such an operation, the ratchet pawl driver may remain movement-decoupled from the movement stop of the rotating plate until the nominal rotation angle is reached. However, once the nominal rotation angle has been exceeded, the movement stop of the rotating plate may come into contact with the ratchet pawl driver, such that the ratchet pawl displacement is carried out, specifically while the multi-disc brake is closing.

After the ratchet pawl displacement has been completed, the ratchet pawl may initially remain in the spring-preloaded position in toothed engagement with the adjustment ring, as the adjustment ring is pressed rotationally fixed between the disc pack and the actuator. Only when the multi-disc brake/clutch is released toward the unloaded state may the adjustment ring be freely rotatable, such that the rotational actuation of the adjustment ring may be carried out, in which the ratchet pawl, which is in toothed engagement with the adjustment ring toothing, is returned to its initial position as the spring-return force is relieved, and in doing so, simultaneously rotates the adjustment ring by the actuation travel so that the ramp assembly expands axially by the adjustment travel.

### BRIEF DESCRIPTION OF THE SEVERAL VIEWS OF THE DRAWINGS

FIG. 1 shows a perspective view of a multi-disc brake/clutch according to the present disclosure.

FIG. 2 shows a cross-sectional view of the multi-disc brake/clutch of FIG. 1 in an installed position.

FIG. 3 shows a perspective view of a ramp assembly of the multi-disc brake/clutch of FIG. 1.

FIG. 4 shows a perspective view of an adjustment ring of the multi-disk brake/clutch of FIG. 1.

FIG. 5 shows a ratchet pawl of the multi-disk brake/clutch of FIG. 1.

FIG. 6 shows a detailed view of a portion of the multi-disk brake/clutch according to the present disclosure.

FIG. 7 shows a perspective view of a ratchet pawl of the multi-disk brake/clutch of FIG. 6.

FIG. 8 shows a detailed view of a portion of the multi-disk brake/clutch of FIG. 6.

FIG. 9 shows a detailed view of a portion of the multi-disk brake/clutch of FIG. 6.

### DETAILED DESCRIPTION

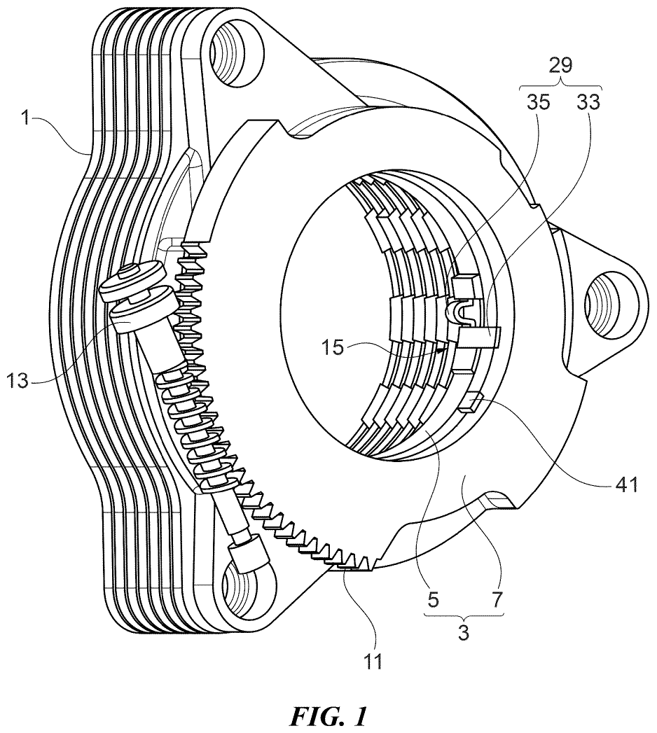

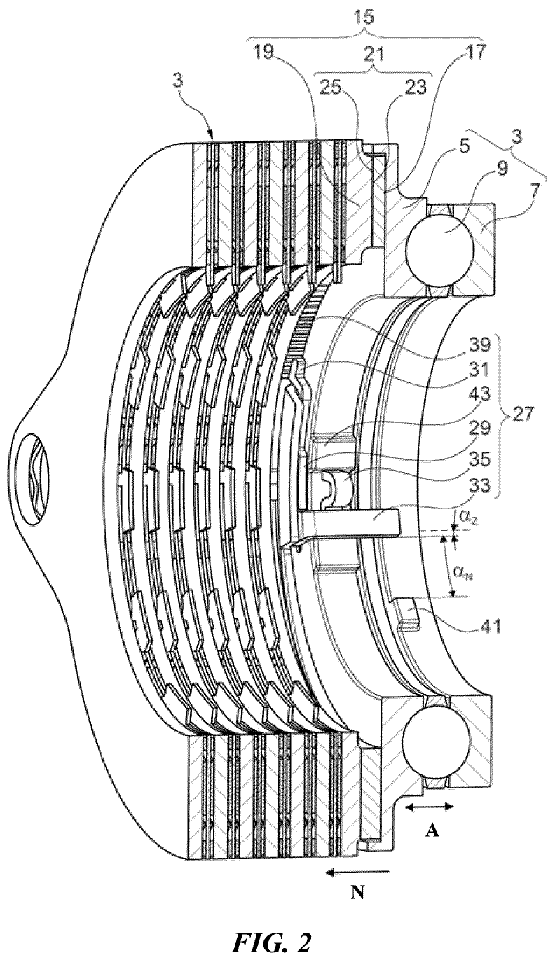

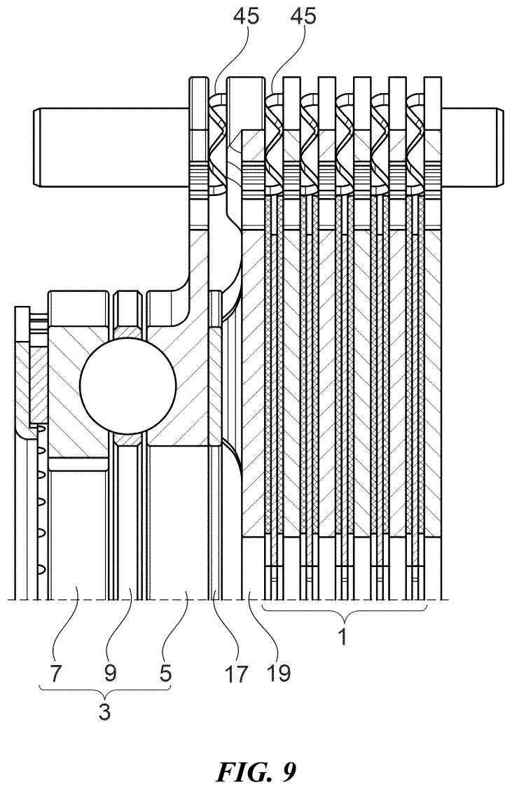

FIG. 1 shows a multi-disc brake with a disc pack 1 and an actuator 3, which may be used to apply a contact pressure to the disc pack 1 in order to load the multi-disc brake. The actuator 3 may include a pair of plates comprising a fixed plate 5 and a rotating plate 7, between which a ball ramp mechanism 9, which is shown in FIGS. 2 and 9, acts. The fixed plate 5 may be adjustable in the axial direction by an actuator travel A, but may be guided in a rotationally fixed manner, whereas the rotating plate 7 may be mounted so as to be rotatable about the disc pack axis, but cannot be adjusted in the axial direction. The rotating plate 7 may be driven by way of a rotary drive 13, as shown in FIG. 1. In FIG. 1, only the pinion spindle of the rotary drive 13 is shown, which may be in toothed engagement with an external toothing 11 of the rotating plate 7. To load the multi-disk brake, the rotary drive may rotate the rotating plate 7 by a rotation angle so that the fixed plate 5 is displaced by the actuator travel A in order to exert the contact pressure on the disc pack 1.

In a wear-free state, the unloaded multi-disc brake has a nominal clearance. Accordingly, the rotary drive 13 may rotate the rotating plate 7 from the unloaded state to the loaded state by a nominal angle of rotation «N. Due to wear, an excess release clearance that exceeds the nominal clearance may occur, which may be reduced by way of an adjustment device 15 described below.

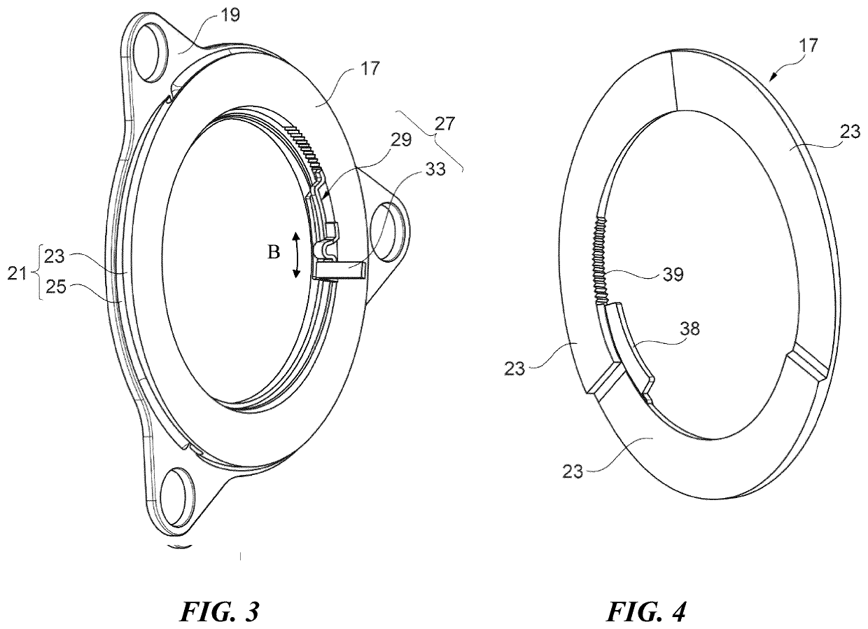

In FIG. 2, the adjustment device 15 has an adjustment ring 17, which is arranged axially between the disc pack 1 and the fixed plate 5 of the actuator 3. A ramp assembly 21 is formed between the adjustment ring 17 and an axially adjacent fixed disc 19 of the disc pack 1. The ramp assembly may include three ramp surfaces 23 of the adjustment ring 17 and three corresponding ramp surfaces 25 of the fixed disc 19, as shown in FIG. 3 and FIG. 4. The adjustment ring 17 may be rotated by an actuation travel B by way of a ratchet mechanism 27. When the adjustment ring 17 is rotated relative to the non-rotating fixed plate 19, the ramp assembly 21 expands axially by an adjustment travel N, as shown in FIG. 2, which may reduce the excess release clearance.

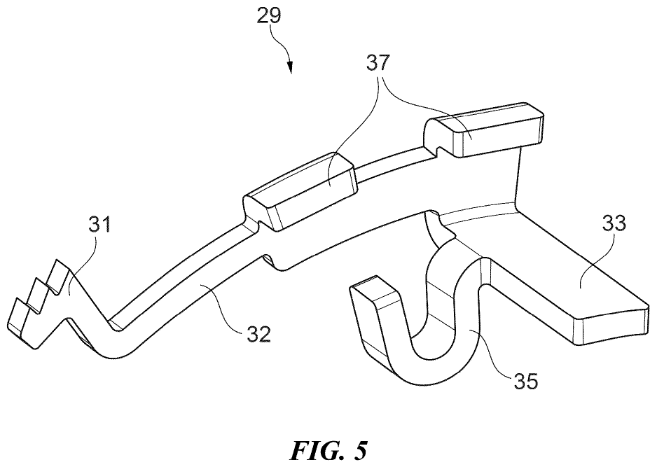

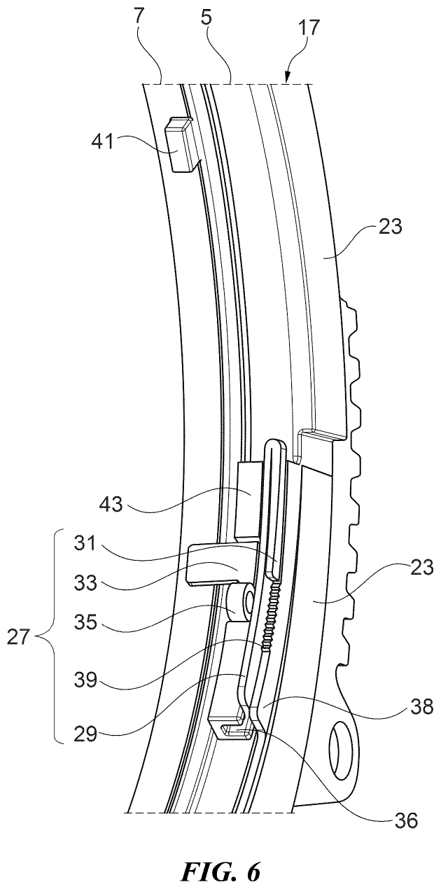

The ratchet mechanism 27 may have a ratchet pawl 29, which is shown in FIG. 5. Accordingly, the ratchet pawl 29 may be configured with a ratchet toothing 31, a radial spring 32, a driver 33, a return spring 35, and angled guide tabs 37. In the installed position, the ratchet pawl 29 may be in toothed engagement with an adjustment ring toothing 39 by way of the ratchet toothing 31 thereof, which may be spring preloaded by way of the radial spring 32. The ratchet pawl 29 may be mounted to the fixed plate 5 by way of the angled guide tabs 37, as well as by way of a guide wall 38 formed on the adjustment ring 17. The ratchet pawl 29 may be guided in the circumferential direction by the actuation travel B. In the assembled condition, the guide tabs 37 of the ratchet pawl 29 may project into corresponding axial recesses 36 of the fixed plate 5, one of which is shown in the embodiment shown in FIG. 6.

In the installed position shown in FIG. 2, the ratchet pawl driver 33 extends in the axial direction beyond the fixed plate 5 to the rotating plate 7. A movement stop 41 may be formed on the inner circumference of the rotating plate 7, which may be brought into abutment with the ratchet pawl driver 33. The ratchet pawl driver 33, together with the return spring 35 formed thereon, may be clamped between two protrusions 43, which is shown in FIG. 2, formed on the inner circumference of the rotating plate 7.

During operation of a multi-disc brake that is set with a nominal clearance (i.e., without excess release clearance), the rotary drive 13 may rotate the rotating plate 7 by a nominal angle of rotation α_{N}, as shown in FIG. 2, from the unloaded state to the loaded state. In such operation, the ratchet pawl driver 33 may remain movement-decoupled from the movement stop 41 of the rotating plate during the rotation of the rotating plate beyond the nominal rotation angle α_{N}. This means that there is no ratchet pawl displacement via the actuation travel B, and therefore, no rotational actuation of the adjustment ring by way of the ratchet mechanism 27, and no readjustment due to wear.

If the multi-disc brake has an excess release clearance, the rotary drive 13 may rotate the rotating plate 7 from the unloaded state to the loaded state by a rotation angle that is greater than the nominal rotation angle α_{N} by an additional angle α_{Z}, as shown in FIG. 2. Until the nominal rotation angle α_{N} is reached, the ratchet pawl driver 33 may remain movement-decoupled from the movement stop 41 of the rotating plate. However, after the nominal rotation angle α_{N} is exceeded, the movement stop 41 of the rotating plate may become movement-coupled with the ratchet pawl driver 33. Accordingly, the ratchet pawl 29 displaces along the adjustment ring toothing 39, for example, by one tooth, when the multi-disc brake is in the loaded state, while the adjustment ring 17 may be pressed rotationally fixed between the disc pack 1 and the rotating plate 7 of the actuator 3. This ratchet pawl displacement may occur under the buildup of a spring-return force, which may be exerted by way of the return spring 35 of the ratchet pawl 29. The ratchet pawl 29 may remain in the preloaded position as long as the multi-disc brake is in the loaded state.

To release the multi-disc brake, the rotary drive 13 may rotates the rotating plate 7 in the opposite direction, whereby the fixed plate 5 is returned in the opposite direction by the actuator travel A, which is shown in FIG. 2. Such rotation of the rotating plate 7 may unload the multi-disc brake. When the multi-disc brake is unloaded, the adjustment ring may no longer be held rotationally fixed, but rather is held rotatably between the disc pack 1 and the rotating plate 7 of the actuator 3. The ratchet mechanism 27 may therefore be used to perform a rotational actuation of the adjustment ring, in which the ratchet pawl 29 that is in toothed engagement with the adjustment ring toothing 39 is returned to the initial position as the spring-return force is relieved, and at the same time the adjustment ring 17 is rotated by the actuation travel B so that the ramp assembly 21 expands axially by the adjustment travel N.

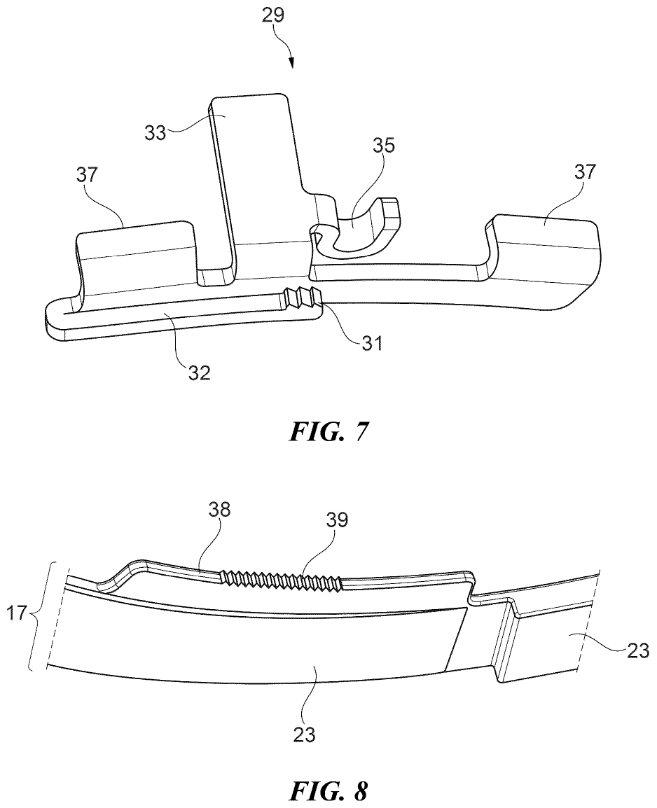

FIGS. 6-9 show a multi-disc brake according to a second embodiment. The overall structure and mode of operation of the multi-disc brake of the second embodiment generally correspond to those of the multi-disc brake of the first embodiment. Reference is therefore made to the previous description. In contrast to the first embodiment, in FIG. 6 and FIG. 8, the adjustment ring toothing 39 is formed directly on an inner circumferential edge of the guide wall 38 of the adjustment ring 17. The web-shaped radial spring 32 is positioned laterally next to the base body of the ratchet pawl by way of a sheet metal flange, as indicated in FIG. 7.

FIG. 9 shows another view of the axial assembly including the actuator 3, the adjustment ring 17, and the disc pack 1. Accordingly, wave springs 45 may be positioned between the individual discs of the disc pack 1, which ensures a sufficiently large clearance between the discs when the brake is unloaded. A wave spring may also be positioned between the fixed plate 5 of the actuator 3 and the axially opposite fixed disc 19 of the disc pack 1. Such a configuration may ensure that the adjustment ring 17 may rotate as smoothly as possible between the fixed disc 19 and the fixed plate 5 when the multi-disc brake is unloaded.

German patent application no. 102024137648.1, filed Dec. 13, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A multi-disc brake/clutch comprising:
a disc pack; and
an actuator configured to apply a contact pressure to the disc pack and having an adjustment device configured to reduce an excess release clearance formed in the disc pack due to wear, the adjustment device including a ramp assembly formed between the disc pack and the actuator with at least one ramp surface rotationally fixed about a disc pack axis and an axially adjacent rotatable ramp surface,
wherein the ramp assembly is configured such that when the rotatable ramp surface is rotationally actuated, the ramp assembly expands axially by an adjustment travel.

2. The multi-disc brake/clutch according to claim 1, wherein the adjustment device includes an adjustment ring arranged axially between the disc pack and the actuator, wherein the rotatable ramp surface is coupled to the adjustment ring, and wherein the rotationally fixed ramp surface is coupled to a rotationally fixed disc of the disc pack.

3. The multi-disc brake/clutch according to claim 1, wherein the actuator comprises a pair of plates including:
a fixed plate adjustable in the axial direction by an actuator travel and rotationally fixed; and
a rotating plate configured to be rotatable and not adjustable in the axial direction, and
wherein a rotary drive is configured to rotate the rotating plate by a rotation angle to load the multi-disc brake/clutch, such that the fixed plate is displaced by the actuator travel such that contact pressure is exerted on the disc pack.

4. The multi-disc brake/clutch according to claim 3, wherein the fixed plate of the actuator is arranged axially adjacent to the adjustment ring, wherein the rotating plate of the actuator is axially spaced apart from the adjustment ring with the fixed plate positioned therebetween, and/or
wherein a ball-ramp mechanism is between the rotating plate and the fixed plate.

5. The multi-disc brake/clutch according to claim 3, wherein the adjustment ring is configured to be rotated by the adjustment device, wherein the adjustment device includes a ratchet mechanism with a ratchet pawl configured to rotationally actuate the adjustment ring by way of ratchet toothing of the ratchet pawl being in toothed engagement with an adjustment ring toothing, and wherein the ratchet pawl is adjustable in a circumferential direction by an actuation travel.

6. The multi-disc brake/clutch according to claim 5, wherein the ratchet pawl is configured to displace in advance of the rotational actuation of the adjustment ring, and displacement of the ratchet pawl occurs along the adjustment ring toothing when the multi-disc brake/clutch is in a loaded state, wherein when the multi-disc brake/clutch is in the loaded state, the adjustment ring is pressed in a rotationally fixed manner between the disc pack and the actuator, and wherein the displacement of the ratchet pawl occurs under buildup of a spring-return force.

7. The multi-disc brake/clutch according to claim 6, wherein the ratchet pawl is configured such that following the displacement of the ratchet pawl, the rotational actuation of the adjustment ring occurs when the multi-disc brake/clutch is in an unloaded state, wherein the adjustment ring is configured to be freely rotatable between the disc pack and the actuator during the rotational actuation of the adjustment ring, such that the ratchet pawl is returned to an initial position as the spring-return force is relieved and simultaneously rotates the adjustment ring by the actuation travel, such that the ramp assembly expands axially by the adjustment travel.

8. The multi-disc brake/clutch according to claim 5, wherein the ratchet pawl is mounted on the fixed plate by way of guide elements such that the ratchet pawl is adjustable in the circumferential direction.

9. The multi-disc brake/clutch according to claim 6, wherein the ratchet pawl includes a driver configured to be coupled to the ratchet pawl such that the ratchet pawl can be moved to a movement stop of the rotating plate for the ratchet pawl displacement.

10. The multi-disc brake/clutch according to claim 9, wherein the multi-disc brake/clutch set is configured such that:
if the multi-disc brake/clutch has a nominal clearance, the rotary drive rotates the rotating plate from the unloaded state to the loaded state by a nominal rotation angle, and in the ratchet pawl driver remains movement-decoupled from the movement stop of the rotating plate during a rotation of the rotating plate beyond the nominal rotation angle; or
if the multi-disc brake has an excess release clearance, the rotary drive rotates the rotating plate from the unloaded state to the loaded state by a rotation angle, the rotation angle being greater than the nominal rotation angle by an additional angle, such that the ratchet pawl driver remains movement-decoupled from the movement stop of the rotating plate until the nominal rotation angle is reached, and becomes movement-coupled with the movement stop in order to perform the ratchet pawl displacement after the nominal rotation angle has been exceeded over the additional rotation angle.

11. The multi-disc brake/clutch according to claim 1, wherein the ramp assembly is configured such that when the rotatable ramp surface is rotationally actuated, the ramp assembly expands axially by an adjustment travel by compensating for the excess clearance.
